(19) United States
(12) Patent Application Publication
(10) Pub. No.: US 2013/0247860 A1
(43) Pub. Date: Sep. 26, 2013

(54) RECOIL STARTER

(71) Applicants: Takehiko Nishimura, Tokyo (JP); Taro Kihara, Tokyo (JP); Seiichi Nieda, Tokyo (JP); Tetsuya Yamada, Tokyo (JP); Kenta Shohuda, Tokyo (JP)

(72) Inventors: Takehiko Nishimura, Tokyo (JP); Taro Kihara, Tokyo (JP); Seiichi Nieda, Tokyo (JP); Tetsuya Yamada, Tokyo (JP); Kenta Shohuda, Tokyo (JP)

(73) Assignee: STARTING INDUSTRIAL CO., LTD., Tokyo (JP)

(21) Appl. No.: 13/989,915

(22) PCT Filed: Nov. 18, 2011
(86) PCT No.: PCT/JP2011/006431

§ 371 Date: May 28, 2013

(30) Foreign Application Priority Data
Dec. 1, 2010 (JP) 2010-268157
Sep. 7, 2011 (JP) 2011-194790

(51) Int. Cl. F02N 3/02

(52) U.S. Cl. CPC F02N 3/02
USPC 123/185.3

(57) ABSTRACT

To provide a recoil starter which is provided with a ratchet member smoothly sliding on an inner peripheral surface of a drive pulley and capable of being manufactured at a low cost. A recoil starter is provided with a circular cross section ratchet member rotatably mounted on a shaft hole. The ratchet member is configured by: a rotary shaft portion inserted into the shaft hole; an arm portion bent at a substantially right angle and extending from the rotary shaft portion; and a distal end portion bent parallel to the rotary shaft portion and extending from the arm portion. The ratchet member rotates upon rotation of a rope reel in an engine start direction, engages with a drive pulley by the rotation, and transmits torque of the rope reel to the drive pulley.

### TECHNICAL FIELD

The present invention relates to a recoil starter in which a recoil rope is pulled to rotate a rope reel so that the rotation of the rope reel is transmitted to a rotary member such as a drive pulley connected to a crankshaft of an engine through a ratchet mechanism so as to start the engine.

### BACKGROUND ART

In the background art, there has been known a recoil starter in which a recoil rope wound around a rope reel is pulled to rotate the rope reel so that the rotation of the rope reel is transmitted to a drive pulley or the like so as to rotate a crankshaft of an engine connected to the drive pulley to thereby start the engine.

In such a recoil starter, a ratchet mechanism for transmitting the torque of the rope reel to the drive pulley is provided. The ratchet mechanism is formed as follows. When the recoil rope is pulled to rotate the rope reel in an engine start direction, the ratchet mechanism engages with the drive pulley so as to transmit the torque to the drive pulley. However, once the engine starts, the ratchet mechanism is prevented from engaging with the drive pulley, so that the torque of the engine cannot be transmitted to the rope reel.

For example, Patent Literature 1 by the same applicant has given disclosure for a ratchet mechanism using a rod-like ratchet member consisting of an arm portion and a rotary shaft portion bent at one end of the arm portion substantially at a right angle therewith. In this ratchet mechanism, the ratchet member is formed as follows. That is, the ratchet member protrudes in an outer diameter direction when the rope reel rotates in the engine start direction. Thus, the protruding ratchet member engages with the drive pulley so as to transmit the torque. On the other hand, once the engine starts, the protruding ratchet member returns to a reception position so as to be prevented from engaging with the drive pulley.

In the ratchet mechanism described in Patent Literature 1, an inclined surface is formed at a distal end of the ratchet member which may abut against an inner peripheral surface of the drive pulley. In this manner, the distal end surface of the ratchet member is prevented from engaging with the edge of an opening of the drive pulley and locking therein.

In the aforementioned recoil starter described in Patent Literature 1, an opening window is provided in the drive pulley so that the ratchet member can engage with the opening window. In addition, another recoil starter of a type in which a ratchet member can engage with a recess portion provided in an inner peripheral wall of a drive pulley has been known, for example, as shown in Patent Literature 2.

### CITATION LIST

### Patent Literature

Patent Literature 1: Japanese Patent No. 3902528
Patent Literature 2: JP-U-61-125671

### SUMMARY OF INVENTION

### Technical Problem

However, in the aforementioned ratchet mechanism described in Patent Literature 1, the ratchet member having an inclined surface formed at the distal end thereof is used. Accordingly, not only processing for bending the ratchet member but also processing for forming the inclined surface are required. To this end, different processing steps are required to thereby result in the increase of the manufacturing cost correspondingly.

Therefore, an object of the invention is to provide a recoil starter in which the aforementioned ratchet mechanism described in Patent Literature 1 is further improved so that the manufacturing cost can be reduced without impairing the function and the performance.

### Solution to Problem

The invention has been accomplished in order to achieve the foregoing object. The invention is characterized as follows.

### (Claim 1)

The invention stated in Claim 1 is characterized in the following point.

That is, a recoil starter according to Claim 1 includes a rope reel in which a ratchet attachment portion is provided at the center thereof, a drive pulley which is disposed to cover the ratchet attachment portion, a ratchet member which is attached to the ratchet attachment portion and disposed on an inner side of the drive pulley, and a control member which is attached coaxially with the rope reel so that the control member can rotate with friction resistance given thereto, and which has an engagement portion capable of engaging with the ratchet member; characterized in that: a shaft hole is formed in the ratchet attachment portion and in parallel with the rotation axis of the rope reel; the ratchet member is a wire-like member having a circular shape in section and rotatably attached to the shaft hole, and includes a rotary shaft portion which is inserted into the shaft hole, an arm portion which is extended from the rotary shaft portion and bent substantially at a right angle therewith, and a distal end portion which is extended from the arm portion and bent in parallel with the rotary shaft portion; and the ratchet member is further arranged so that, when the rope reel rotates in an engine start direction, the arm portion is thrust against the engagement portion of the control member so that the distal end portion is rotated to protrude in an outer diameter direction and the rotated distal end portion engages with the drive pulley so as to transmit torque of the rope reel to the drive pulley.

### (Claim 2)

The invention stated in Claim 2 is characterized in the following point as well as the aforementioned characterized point of the invention stated in Claim 1.

That is, the invention stated in Claim 2 is characterized in that: an opening is formed in the drive pulley so that the distal end portion of the ratchet member rotated to protrude in the outer diameter direction can penetrate the opening.

### (Claim 3)

The invention stated in Claim 3 is characterized in the following point as well as the aforementioned characterized point of the invention stated in Claim 1.

That is, the invention stated in Claim 3 is characterized in that: a recess portion for receiving the distal end portion of the ratchet member rotated to protrude in the outer diameter direction is formed in the drive pulley.

### (Claim 4)

The invention stated in Claim 4 is characterized in the following point as well as the aforementioned characterized point of the invention stated in Claim 2 or 3.

The invention stated in Claim 4 is characterized in that: when the distal end portion of the ratchet member is rotated to protrude in the outer diameter direction to thereby engage with the drive pulley, the distal end portion is supported by a reception portion formed in the rope pulley.

### (Claim 5)

The invention stated in Claim 5 is characterized in the following point as well as the aforementioned characterized point of the invention stated in any one of Claims 1 through 4.

That is, the invention stated in Claim 5 is characterized by further comprising: an urging unit for urging the ratchet member in a direction to prevent the distal end portion from protruding in the outer diameter direction.

### Advantageous Effects of Invention

In the invention stated in Claim 1, as described above, the ratchet member is a wire-like member having a circular shape in section and rotatably attached to the shaft hole formed in the ratchet attachment portion, and the ratchet member includes a rotary shaft portion which is inserted into the shaft hole, an arm portion which is extended from the rotary shaft portion and bent substantially at a right angle therewith, and a distal end portion which is extended from the arm portion and bent in parallel with the rotary shaft portion. Accordingly, it is not necessary to form an inclined surface at the distal end, so it is possible to manufacture the ratchet member only by a bending process and it is possible to reduce the manufacturing cost.

In addition, the distal end portion of the ratchet member is a wire-like member having a circular shape in section and provided in parallel with the rotation axis. Since the curved surface in the axially side surface of the distal end surface abuts against an inner peripheral surface of the drive pulley, the sliding resistance when the ratchet member slides on the drive pulley can be formed to be small. That is, when the ratchet member is rotated to protrude in the outer diameter direction, the distal end portion can slide on the inner peripheral surface of the drive pulley smoothly. Thus, the ratchet member can be prevented from being locked on the drive pulley.

In addition, in the invention stated in Claim 2, as described above, an opening is formed in the drive pulley so that the distal end portion of the ratchet member rotated to protrude in the outer diameter direction can penetrate the opening. Accordingly, when the rope reel rotates in the engine start direction, the ratchet member which has one end supported in the shaft hole and the other end supported on the reception portion rotates together with the rope reel. At this time, the ratchet member penetrates the opening of the drive pulley, so that the torque of the rope pulley is transmitted to the drive pulley through the opening.

In addition, in the invention stated in Claim 3, as described above, a recess portion for receiving the distal end portion of the ratchet member rotated to protrude in the outer diameter direction is formed in the drive pulley. Accordingly, when the rope reel rotates in the engine start direction, the distal end portion of the ratchet member engages with the recess portion of the drive pulley. Thus, the torque of the rope reel is transmitted to the drive pulley through the recess portion.

According to the invention stated in this claim, both the rotary shaft portion and the distal end portion of the ratchet member suffering a load are provided in parallel with the rotation axis. There is therefore no fear that the load is applied in a direction to tilt the ratchet member or in a direction to make the ratchet member drop out. Thus, the ratchet member can be prevented from dropping out, for example, as compared with the ratchet member described in Patent Literature 2 etc.

In addition, in the invention stated in Claim 4, as described above, when the distal end portion of the ratchet member is rotated to protrude in the outer diameter direction so as to engage with the drive pulley, the distal end portion is supported on the reception portion formed in the rope reel. Accordingly, even if a load on the engine side is applied to the ratchet member when the ratchet member engages with the drive pulley so as to start the engine, the ratchet member can be effectively prevented from tilting because the opposite end portions of the ratchet member on the rotary shaft portion side and the distal end portion side are supported on the rope reel.

In addition, the distal end portion supported on the reception portion is provided as a shaft parallel with the rotation axis. Accordingly, even if the distal end portion is formed to be not large in the radial direction, the distal end portion and the reception portion can be brought into engagement in a wide range. Thus, the load at the time of start of the engine can be dispersed to enhance the load-bearing property, and reduction of the size in the radial direction can be achieved.

In addition, in the invention stated in Claim 5, as described above, an urging unit for urging the ratchet member in a direction to prevent the distal end portion from protruding in the outer diameter direction is provided. Accordingly, when the recoil rope is returned, the ratchet is urged in a reception direction. Thus, the ratchet member can be surely retracted to a non-engagement position.

### BRIEF DESCRIPTION OF DRAWINGS

FIG. 1 A sectional view of a recoil starter according to a first embodiment.

FIG. 2 A side view (a) and a bottom view (b) of a ratchet member according to the first embodiment.

FIG. 3 A view showing the recoil starter according to the first embodiment so as to show a state where the ratchet member is in a reception position. The view is a sectional view of the recoil starter according to the first embodiment.

FIG. 4 A view showing a state where the ratchet member according to the first embodiment is pushed out from the reception position to an engagement position.

FIG. 5 A view showing the recoil starter according to the first embodiment so as to show a state where the ratchet member is in the engagement position.

FIG. 6 A sectional view of a recoil starter according to a second embodiment.

FIG. 7 A view showing the recoil starter according to the second embodiment so as to show a state where a ratchet member is in a reception position. The view is a sectional view of the recoil starter according to the first embodiment.

FIG. 8 A view showing a state where the ratchet member according to the second embodiment is pushed out from the reception position to an engagement position.

FIG. 9 A view showing the recoil starter according to the second embodiment so as to show a state where the ratchet member is in the engagement position.

FIG. 10 A side view (a) and a bottom view (b) of a ratchet member according to a first modification.

FIG. 11 A sectional view of a recoil starter according to a second modification.

### DESCRIPTION OF EMBODIMENTS

### First Embodiment

A first embodiment of the invention will be described with reference to the drawings.

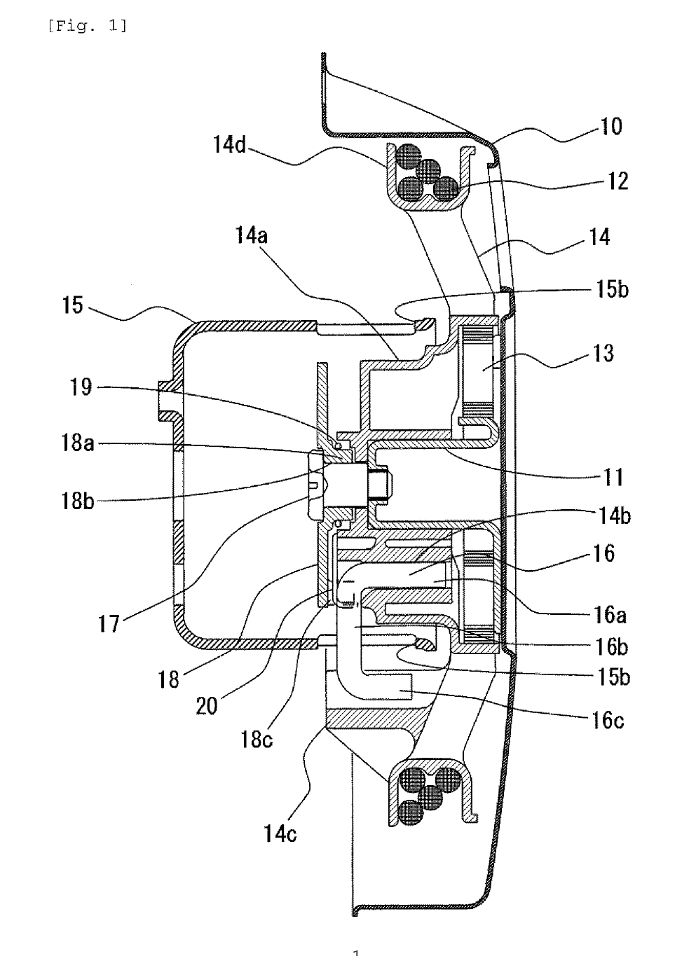

In a recoil starter according to this embodiment, as shown in FIG. 1, a reel support shaft 11 is formed on an inner side surface of a starter case 10 formed to receive main constituents of the recoil starter and cover a side surface portion of an engine, so that the reel support shaft 11 can face a crankshaft of the engine. A rope reel 14 on which a recoil rope 12 is wound is rotatably attached to an outer periphery of the reel support shaft 11.

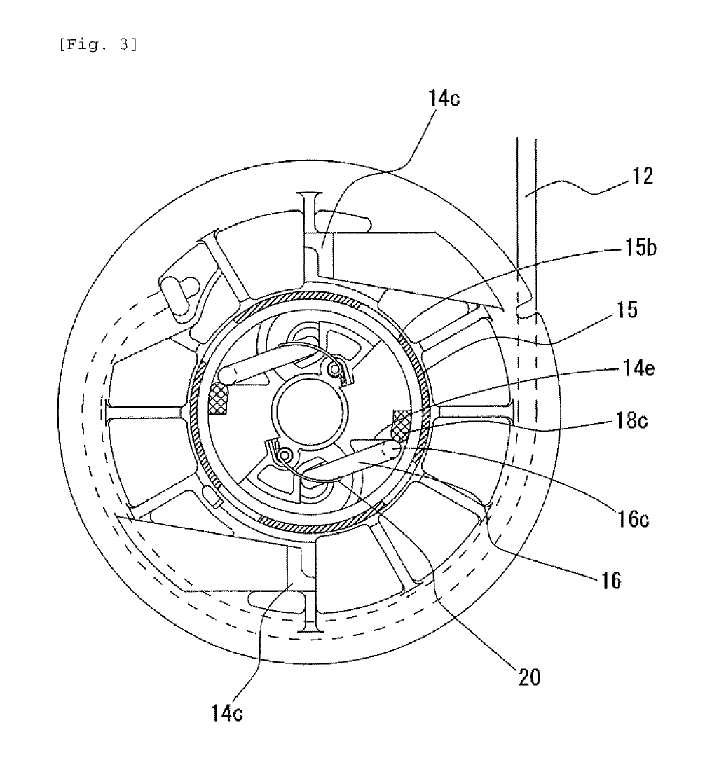

As shown in FIG. 1 and FIG. 3, the recoil rope 12 is wound around a reel portion 14d formed in an outer periphery of the rope reel 14, and has one end fixed to the rope reel 14 and the other end extracted to the outside of the starter case 10 from an opening (not shown) formed in the starter case 10. The rope reel 14 is formed so as to be driven and rotated around the reel support shaft 11 as a rotation axis when the extracted recoil rope 12 is pulled.

As shown in FIG. 1, a recoil spring 13 for rotating the rope reel 14 rotated by the pull of the recoil rope 12 in an opposite direction so as to rewind the extracted recoil rope 12 on the rope reel 14 is disposed between the rope reel 14 and the reel support shaft 11. The recoil spring 13 has one end fixed to the rope reel 14 and the other end fixed to the reel support shaft 11. The recoil spring 13 operates as follows. That is, when the recoil rope 12 is operated and pulled to rotate the rope reel 14, torque is accumulated in the recoil spring 13. As soon as the recoil rope 12 is released, the rope reel 14 is rotated in the opposite direction due to the torque accumulated in the recoil spring 13 so that the recoil rope 12 extracted to the outside of the starter case 10 is rewound on the rope reel 14.

As shown in FIG. 1, a columnar ratchet attachment portion 14a is formed at the center of the rope reel 14 so as to protrude in a direction to leave the starter case 10. A substantially bottomed cylindrical drive pulley 15 is disposed to cover the ratchet attachment portion 14a. The drive pulley 15 is to transmit the torque of the rope reel 14 to the engine when the drive pulley 15 is attached to the crankshaft of the engine. As shown in FIG. 3 and so on, four openings 15b are formed circumferentially at an equal interval in a peripheral wall of the drive pulley 15 so that the opening 15b can engage with ratchet members 16 which will be described later.

In addition, two shaft holes 14b whose axes are parallel to the axis of the aforementioned reel support shaft 11 (the rotation axis of the rope reel 14) are formed in eccentric positions in the ratchet attachment portion 14a of the rope reel 14. The ratchet members 16 are rotatably supported in the two shaft holes 14b respectively. Thus, the ratchet members 16 are disposed on an inner side of the drive pulley 15. The ratchet members 16 are formed so that, when the ratchet members 16 engage with the drive pulley 15, the rotation of the rope reel 14 in an engine start direction can be transmitted to the drive pulley 15.

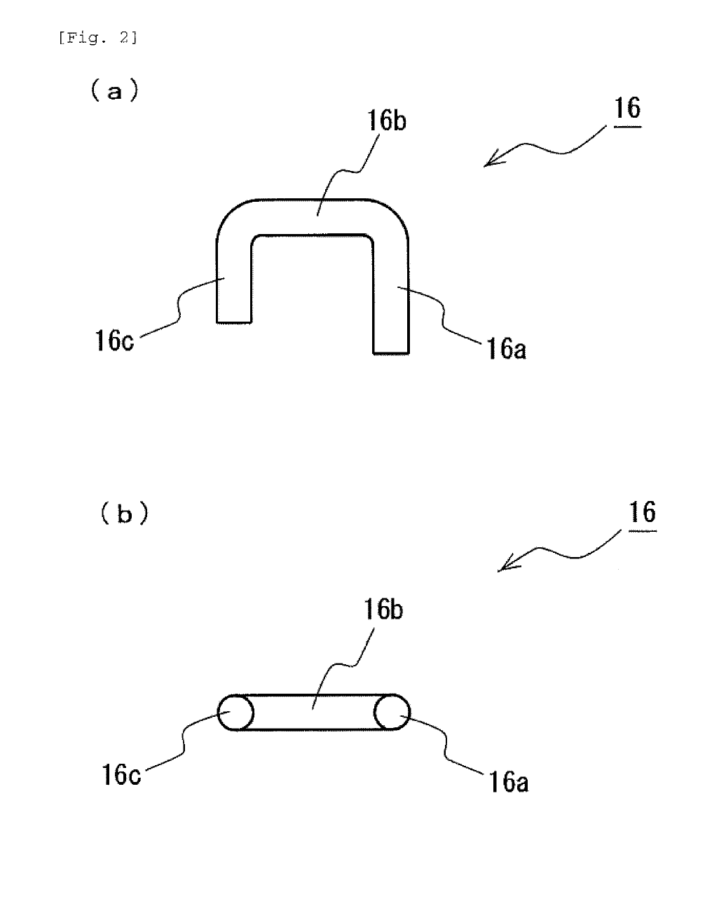

As shown in FIG. 2, each ratchet member 16 is a wire-like member having a circular shape in section and made of a raw material such as steel. The ratchet member 16 consists of a rotary shaft portion 16a which is inserted into the aforementioned shaft hole 14b, an arm portion 16b in which an open-end portion side of the rotary shaft portion 16a is bent substantially at a right angle, and a distal end portion 16c in which a distal end of the arm portion 16b is bent in parallel with the rotary shaft portion 16a. The ratchet member 16 is a substantially U-shaped member in which the distal end portion 16c is formed to be slightly shorter than the rotary shaft portion 16a.

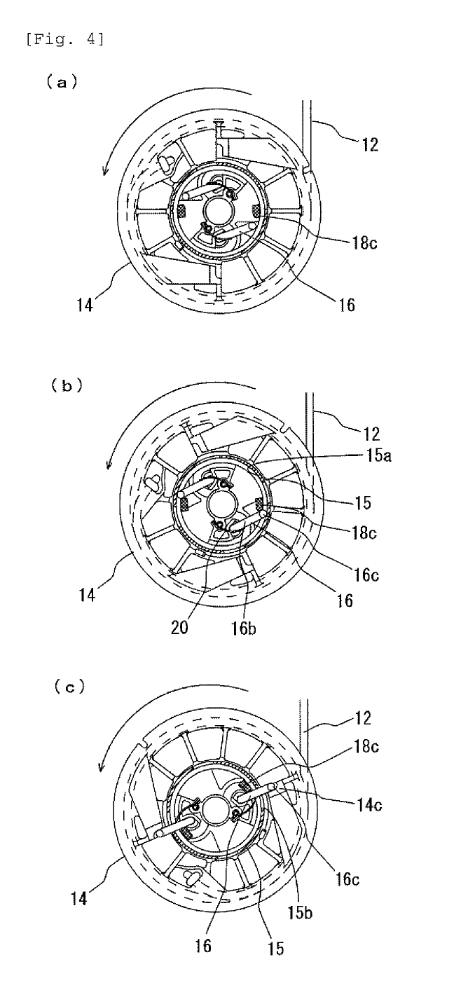

The ratchet member 16 can rotate in a predetermined range around the rotary shaft portion 16a as shown in FIG. 4. To describe in detail, the ratchet member 16 can rotate between a reception position shown in FIG. 4(a) and an engagement position shown in FIG. 4(c).

In the reception position shown in FIG. 4(a), the rotation of the ratchet member 16 is limited because the distal end portion 16c abuts against an inner side of a notch 14e provided in the ratchet attachment portion 14a (see FIG. 3). On the other hand, in the engagement position shown in FIG. 4(c), the rotation of the ratchet member 16 is limited because the distal end portion 16c abuts against a reception portion 14c provided farther in an outer diameter direction than the ratchet attachment portion 14a of the rope reel 14.

A spring seat is formed near the shaft hole 14b. A torsion coil spring 20 retained in the spring seat acts on the ratchet member 16 so as to urge the ratchet member 16 in a direction to prevent the distal end portion 16c from protruding in the outer diameter direction of the rope reel 14. Thus, the ratchet member 16 is urged to the aforementioned reception position in the state where the rope reel 14 is not rotating in the engine start direction.

In addition, as shown in FIG. 1, a control member 18 is attached to an end surface of the aforementioned reel support shaft 11 by a set screw 17. By the control member 18, the rope reel 14 is prevented from dropping out from the reel support shaft 11. In the control member 18, a screw hole 18b which is penetrated by the set screw 17 is formed in a cylindrical portion 18a at the center of the control member 18. A friction spring 19 is attached to the periphery of the cylindrical portion 18a. The friction spring 19 fastens the cylindrical portion 18a of the control member 18 from its outer periphery, so that a predetermined frictional force (at least a frictional force which can act against the urging force of the torsion coil spring 20) can be generated between the cylindrical portion 18a and the set screw 17. Thus, friction resistance is given to the control member 18 against the reel support shaft 11 so that the control member 18 can be rotatably attached to the reel support shaft 11.

An engagement portion 18c which can engage with the ratchet member 16 is formed to protrude in the surface of the control member 18 on the ratchet member 16 side, as shown in FIG. 1, FIG. 3 and so on. The engagement portion 18c is to engage with the ratchet member 16 so as to rotate the ratchet member 16 in a direction (engagement position) to abut against the reception portion 14c when the ratchet member 16 is rotated in accordance with the rotation of the rope reel 14. As will be described later, the rotated ratchet member 16 penetrates the opening 15b of the drive pulley 15 to engage with the edge of the opening 15b, with the result that the torque of the rope reel 14 can be transmitted to the drive pulley 15.

Next, description will be made on the operation of the recoil starter according to this embodiment.

Before the operation of starting the engine, each ratchet member 16 is urged to the reception position by the action of the torsion coil spring 20, and the distal end portion 16c is disposed to leave the drive pulley 15, as shown in FIG. 3.

When the recoil rope 12 is pulled in this state, the rope reel 14 rotates so that each ratchet member 16 rotates together with the rope reel 14, as shown in FIG. 4(a). On this occasion, because the control member 18 is attached to the reel support shaft 11 with a predetermined rotation resistance, the control member 18 does not rotate, but the arm portion 16b of the ratchet member 16 abuts against the engagement portion 18c of the control member 18, as shown in FIG. 4(b). Then, the ratchet member 16 further rotates together with the rope reel 14. Thus, the arm portion 16b is thrust against the engagement portion 18c, and the distal end portion 16c rotates to protrude in the outer diameter direction. When an inner peripheral surface 15a of the drive pulley 15 is located on an outer peripheral side of the ratchet member 16 at this time, the distal end portion 16c of the ratchet member 16 is rotated to reach the opening 15b of the drive pulley 15 while sliding on the inner peripheral surface 15a of the drive pulley 15.

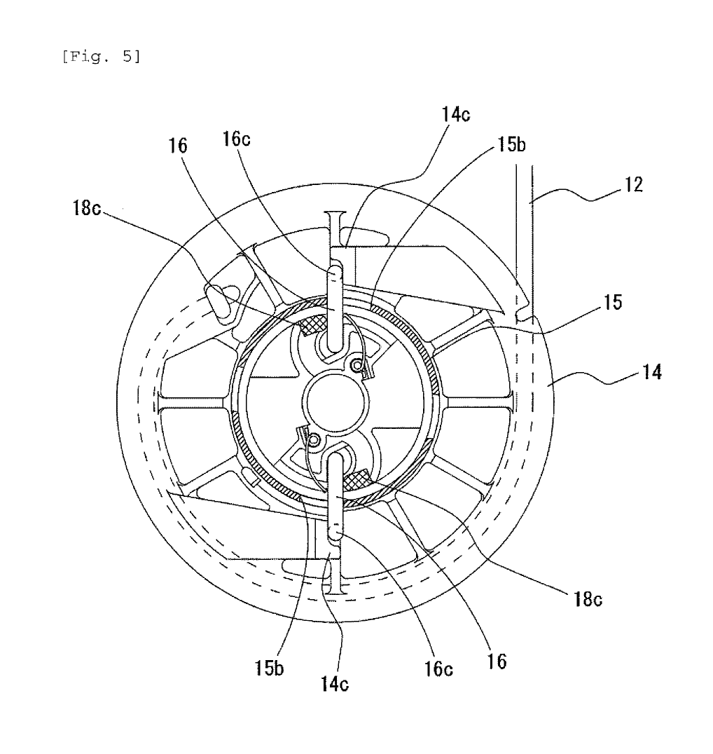

When the distal end portion 16c of the ratchet member 16 rotates to reach the opening 15b of the drive pulley 15, the distal end portion 16c of the ratchet member 16 penetrates the opening 15b of the drive pulley 15, and the distal end portion 16c abuts against the reception portion 14c formed in the outer diameter direction of the rope reel 14, as shown in FIG. 4(c). Thus, the rotation of the ratchet member 16 is stopped so that the engagement position shown in FIG. 5 is kept. Then, the ratchet member 16 also rotates together with the rope reel 14 while keeping the engagement position. On this occasion, due to the engagement between the edge of the opening 15b of the drive pulley 15 and the arm portion 16b of the ratchet member 16, the drive pulley 15 also rotates together with the rope reel 14. Thus, the engine can be started.

When the rope reel 14 rotates in the state shown in FIG. 4(c), the control member 18 is pressed onto the ratchet member 16 through the engagement portion 18c. Thus, the control member 18 is rotated in the engine start direction together with the rope reel 14 against the rotation resistance generated by the friction spring 19.

After the start of the engine, the drive pulley 15 rotates in concert with the rotation of the crankshaft so that the rope reel 14 rotates reversely relatively. Thus, the ratchet member 16 is pushed back to the edge of the opening 15b of the drive pulley 15, so that the ratchet member 16 rotates toward the reception position. As a result, the ratchet member 16 leaves the drive pulley 15. Accordingly, the ratchet member 16 is formed to prevent the rotation of the engine from being transmitted to the rope reel 14.

Even if the engine is not started, the rope reel 14 can be rotated in the opposite direction so as to rewind the recoil rope 12 on the rope reel 14 due to the torque accumulated in the recoil spring 13 when the recoil rope 12 is loosened. On this occasion, the ratchet member 16 also rotates in the opposite direction together with the rope reel 14 so that the arm portion 16b of the ratchet member 16 can be pushed back by the engagement portion 18c of the control member 18. Thus, the ratchet member 16 further rotates to the reception position by the action of the torsion coil spring 20.

In this manner, according to this embodiment, processing on the end surface of each ratchet member 16 and so on is not required. Therefore, the ratchet member 16 can be manufactured only by a bending process so that the ratchet member 16 can be manufactured at a low cost.

In addition, since the distal end portion 16c of the ratchet member 16 is a wire-like member having a circular shape in section and provided in parallel with the rotation axis of the rope reel 14 (the reel support shaft 11), the curved surface in the axially side surface of the distal end portion 16c abuts against the inner peripheral surface 15a of the drive pulley 15 so that the sliding resistance when the distal end portion 16c slides on the inner peripheral surface 15a of the drive pulley 15 can be formed to be small. That is, when the ratchet member 16 rotates to protrude in the outer diameter direction, the distal end portion 16c can slide on the inner peripheral surface 15a of the drive pulley 15 smoothly. Thus, the ratchet member 16 and the drive pulley 15 can be prevented from locking on each other.

In addition, the opening 15b which can be penetrated by the distal end portion 16c of the ratchet member 16 rotated to protrude in the outer diameter direction is formed in the drive pulley 15, and the distal end portion 16c penetrating the opening 15b is supported on the reception portion 14c formed in the rope reel 14. Thus, when the rope reel 14 rotates in the engine start direction, the ratchet member 16 which has one end (the rotary shaft portion 16a) supported in the shaft hole 14b and the other end (the distal end portion 16c) supported on the reception portion 14c rotates together with the rope reel 14. On this occasion, since the ratchet member 16 penetrates the opening 15b of the drive pulley 15, the torque of the rope reel 14 is transmitted to the drive pulley 15 through the opening 15b.

According to this embodiment, the distal end portion 16c of the ratchet member 16 supported on the reception portion 14c is provided as a shaft parallel with the rotation axis of the rope reel 14 (the reel support shaft 11). Thus, even if the distal end portion 16c is formed to be not large in the radial direction, the distal end portion 16c and the reception portion 14c can be brought into engagement in a wide range. Thus, the load at the time of start of the engine can be dispersed to enhance the load-bearing property, and reduction of the size in the radial direction can be achieved.

### Second Embodiment

Next, description will be made about a second embodiment of the invention. This embodiment is characterized in the point that the drive pulley 15 is formed into a different shape. That is, the drive pulley 15 allows the ratchet member 16 to engage with the opening 15b in the first embodiment whereas the drive pulley 15 allows the ratchet member 16 to engage with a recess portion 15c provided in an inner peripheral wall in the second embodiment.

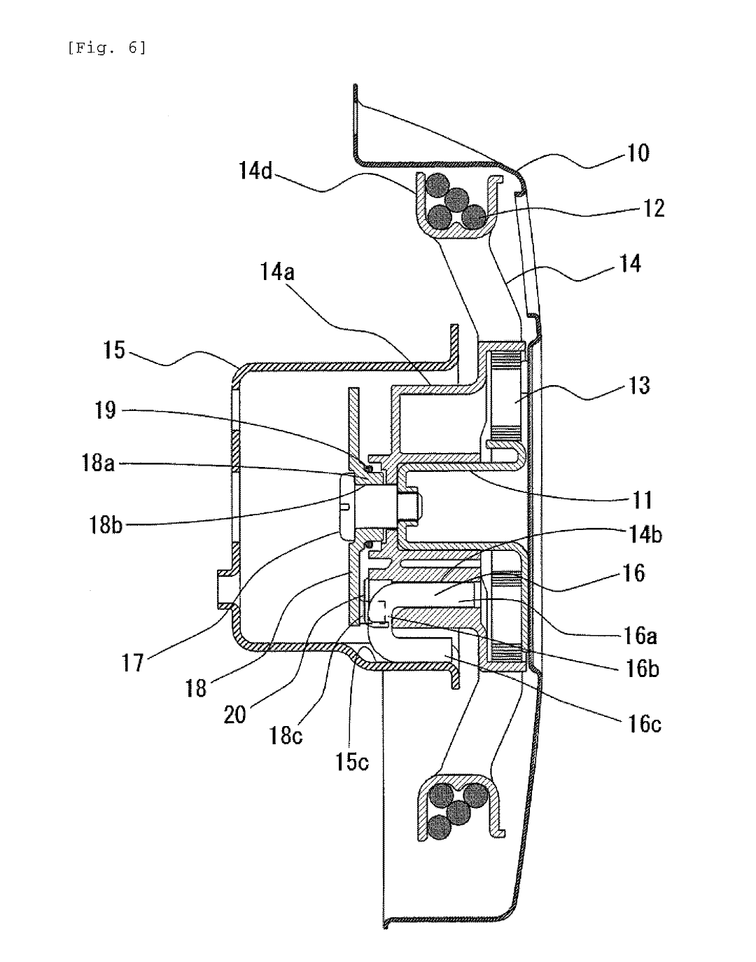

In the recoil starter according to this embodiment, as shown in FIG. 6, a reel support shaft 11 is formed on an inner side surface of a starter case 10 formed to receive main constituents of the recoil starter and cover a side surface portion of an engine, so that the reel support shaft 11 can face a crankshaft of the engine. A rope reel 14 on which a recoil rope 12 is wound is rotatably attached to an outer periphery of the reel support shaft 11.

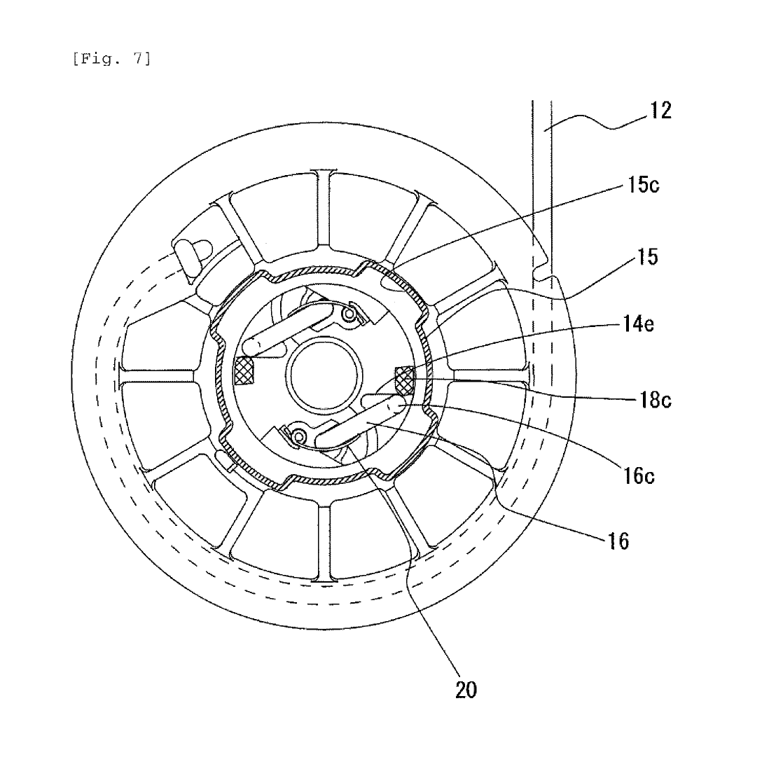

As shown in FIG. 6 and FIG. 7, the recoil rope 12 is wound around a reel portion 14d formed in an outer periphery of the rope reel 14, and has one end fixed to the rope reel 14 and the other end extracted to the outside of the starter case 10 from an opening (not shown) formed in the starter case 10. The rope reel 14 is formed so as to be driven and rotated around the reel support shaft 11 as a rotation axis when the extracted recoil rope 12 is pulled.

As shown in FIG. 6, a recoil spring 13 for rotating the rope reel 14 rotated by the pull of the recoil rope 12 in an opposite direction so as to rewind the extracted recoil rope 12 on the rope reel 14 is disposed between the rope reel 14 and the reel support shaft 11. The recoil spring 13 has one end fixed to the rope reel 14 and the other end fixed to the reel support shaft 11. The recoil spring 13 operates as follows. That is, when the recoil rope 12 is operated and pulled to rotate the rope reel 14, torque is accumulated in the recoil spring 13. As soon as the recoil rope 12 is released, the rope reel 14 is rotated in the opposite direction due to the torque accumulated in the recoil spring 13 so that the recoil rope 12 extracted to the outside of the starter case 10 is rewound on the rope reel 14.

As shown in FIG. 6, a columnar ratchet attachment portion 14a is formed at the center of the rope reel 14 so as to protrude in a direction to leave the starter case 10. A substantially bottomed cylindrical drive pulley 15 is disposed to cover the ratchet attachment portion 14a. The drive pulley 15 is to transmit the torque of the rope reel 14 to the engine when the drive pulley 15 is attached to the crankshaft of the engine. As shown in FIG. 7 and so on, four recess portions 15c are formed circumferentially at an equal interval in the peripheral wall of the drive pulley 15. When ratchet members 16 which will be described later rotate to protrude in the outer diameter direction, the recess portions 15c can receive distal end portions 16c of the ratchet members 16.

In addition, two shaft holes 14b whose axes are parallel to the axis of the aforementioned reel support shaft 11 (the rotation axis of the rope reel 14) are formed in eccentric positions on the ratchet attachment portion 14a of the rope reel 14. The ratchet members 16 are rotatably supported in the two shaft holes 14b respectively. Thus, the ratchet members 16 are disposed on an inner side of the drive pulley 15. The ratchet members 16 are formed so that, when the ratchet members 16 engage with the drive pulley 15, the rotation of the rope reel 14 in an engine start direction can be transmitted to the drive pulley 15.

As shown in FIG. 2, each ratchet member 16 is a wire-like member having a circular shape in section and made of a raw material such as steel. The ratchet member 16 consists of a rotary shaft portion 16a which is inserted into the aforementioned shaft hole 14b, an arm portion 16b in which an open-end portion side of the rotary shaft portion 16a is bent substantially at a right angle, and a distal end portion 16c in which a distal end of the arm portion 16b is bent in parallel with the rotary shaft portion 16a. The ratchet member 16 is a substantially U-shaped member in which the distal end portion 16c is formed to be slightly shorter than the rotary shaft portion 16a.

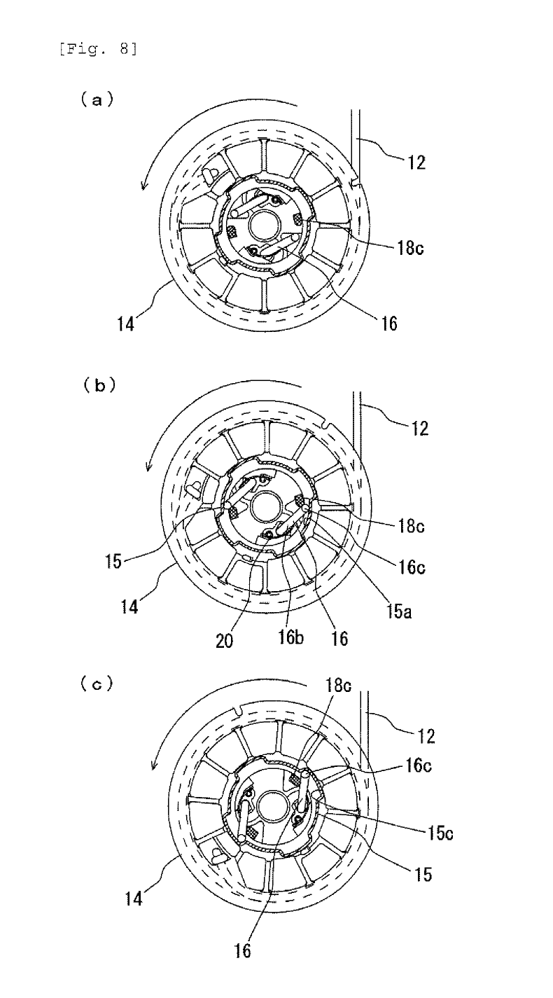

The ratchet member 16 can rotate in a predetermined range around the rotary shaft portion 16a, as shown in FIG. 8. To describe in detail, the ratchet member 16 can rotate between a reception position shown in FIG. 8(a) and an engagement position shown in FIG. 8(c).

In the reception position shown in FIG. 8(a), the rotation of the ratchet member 16 is limited because the distal end portion 16c abuts against an inner side of a notch 14e provided in the ratchet attachment portion 14a (see FIG. 7). On the other hand, in the engagement position shown in FIG. 8(c), the rotation of the ratchet member 16 is limited because the distal end portion 16c abuts against the recess portion 15c of the drive pulley 15.

A spring seat is formed near the shaft hole 14b. A torsion coil spring 20 retained in the spring seat acts on the ratchet member 16 so as to urge the ratchet member 16 in a direction to prevent the distal end portion 16c from protruding in the outer diameter direction of the rope reel 14: Thus, the ratchet member 16 is urged to the aforementioned reception position in the state where the rope reel 14 is not rotating in the engine start direction.

In addition, as shown in FIG. 6, a control member 18 is attached to an end surface of the aforementioned reel support shaft 11 by a set screw 17. By the control member 18, the rope reel 14 can be prevented from dropping out from the reel support shaft 11. In the control member 18, a screw hole 18b which is penetrated by the set screw 17 is formed in a cylindrical portion 18a at the center of the control member 18. A friction spring 19 is attached to the periphery of the cylindrical portion 18a. The friction spring 19 fastens the cylindrical portion 18a of the control member 18 from its outer periphery, so that a predetermined frictional force (at least a frictional force which can act against the urging force of the torsion coil spring 20) can be generated between the cylindrical portion 18a and the set screw 17. Thus, friction resistance is given to the control member 18 against the reel support shaft 11 so that the control member 18 can be rotatably attached to the reel support shaft 11.

An engagement portion 18c which can engage with the ratchet member 16 is formed to protrude in the surface of the control member 18 on the ratchet member 16 side, as shown in FIG. 6, FIG. 7 and so on. The engagement portion 18c is to engage with the ratchet member 16 so as to rotate the ratchet member 16 in a direction (engagement position) to abut against the recess portion 15c of the drive pulley 15 when the ratchet member 16 is rotated in accordance with the rotation of the rope reel 14. As will be described later, the rotated ratchet member 16 engages with the recess portion 15c of the drive pulley 15, with the result that the torque of the rope reel 14 can be transmitted to the drive pulley 15.

Next, description will be made on the operation of the recoil starter according to this embodiment.

Before the operation of starting the engine, each ratchet member 16 is urged to the reception position by the action of the torsion coil spring 20, and the distal end portion 16c is disposed to leave the drive pulley 15, as shown in FIG. 7.

When the recoil rope 12 is pulled in this state, the rope reel 14 rotates and each ratchet member 16 rotates together with the rope reel 14, as shown in FIG. 8(a). On this occasion, since the control member 18 is attached to the reel support shaft 11 with a predetermined rotation resistance, the control member 18 does not rotate, but the arm portion 16b of the ratchet member 16 abuts against the engagement portion 18c of the control member 18, as shown in FIG. 8(b). Then, the ratchet member 16 further rotates together with the rope reel 14. Thus, the arm portion 16b is thrust against the engagement portion 18c, and the distal end portion 16c rotates to protrude in the outer diameter direction. When the inner peripheral surface 15a of the drive pulley 15 other than the recess portions 15c is located on an outer peripheral side of the ratchet member 16 at this time, the distal end portion 16c of the ratchet member 16 is rotated to reach the recess portion 15c of the drive pulley 15 while sliding on the inner peripheral surface 15a of the drive pulley 15.

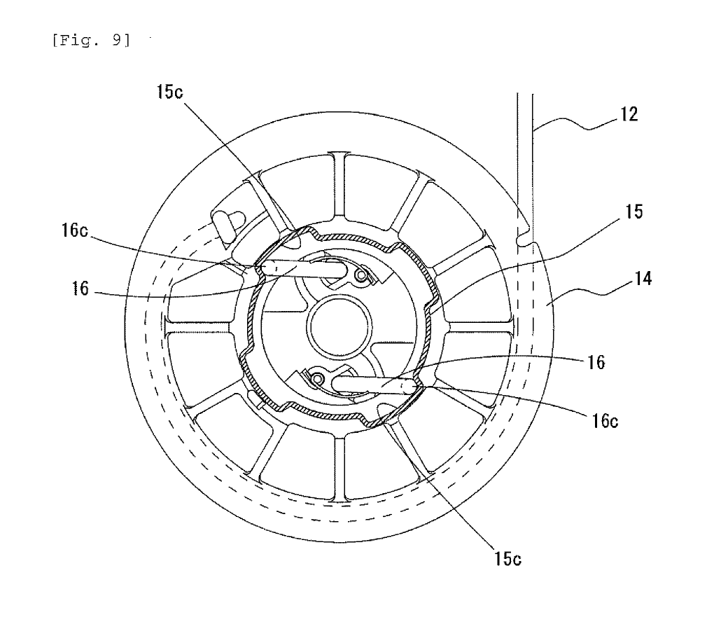

When the distal end portion 16c of the ratchet member 16 rotates to reach the recess portion 15c of the drive pulley 15, the distal end portion 16c of the ratchet member 16 engages with the recess portion 15c of the drive pulley 15, as shown in FIG. 8(c). As a result, the rotation of the ratchet member 16 is stopped so that the engagement position shown in FIG. 9 is kept. Then, the ratchet member 16 and the drive pulley 15 rotate together with the rope reel 14 while the engagement position is kept. Thus, the engine can be started.

When the rope reel 14 rotates in the state shown in FIG. 8(c), the control member 18 is pressed onto the ratchet member 16 through the engagement portion 18c. Thus, the control member 18 is rotated in the engine start direction together with the rope reel 14 against the rotation resistance generated by the friction spring 19.

After the start of the engine, the drive pulley 15 rotates in concert with the rotation of the crankshaft so that the rope reel 14 rotates reversely relatively. Thus, the ratchet member 16 is pushed back to the edge of the recess portion 15c of the drive pulley 15, so that the ratchet member 16 rotates toward the reception position. As a result, the ratchet member 16 leaves the drive pulley 15. Accordingly, the ratchet member 16 is formed to prevent the rotation of the engine from being transmitted to the rope reel 14.

Even if the engine is not started, the rope reel 14 is rotated in the opposite direction so as to rewind the recoil rope 12 on the rope reel 14 due to the torque accumulated in the recoil spring 13 when the recoil rope 12 is loosened. On this occasion, the ratchet member 16 also rotates in the opposite direction together with the rope reel 14 so that the arm portion 16b of the ratchet member 16 is pushed back by the engagement portion 18c of the control member 18 and the ratchet member 16 further rotates to the reception position by the action of the torsion coil spring 20.

In this manner, according to this embodiment, processing on the end surface of each ratchet member 16 and so on is not required. Therefore, the ratchet member 16 can be manufactured only by a bending process so that the ratchet member 16 can be manufactured at a low cost.

In addition, since the distal end portion 16c of the ratchet member 16 is a wire-like member having a circular shape in section and provided in parallel with the rotation axis of the rope reel 14 (the reel support shaft 11), the curved surface in the axially side surface of the distal end portion 16c abuts against the inner peripheral surface 15a of the drive pulley 15 so that the sliding resistance when the distal end portion 16c slides on the inner peripheral surface 15a of the drive pulley 15 can be formed to be small. That is, when the ratchet member 16 rotates to protrude in the outer diameter direction, the distal end portion 16c can slide on the inner peripheral surface 15a of the drive pulley 15 smoothly so that the ratchet member 16 and the drive pulley 15 are prevented from locking on each other in any position except the recess portions 15c.

In addition, each recess portion 15c for receiving the distal end portion 16c of the ratchet member 16 rotated to protrude in the outer diameter direction is formed in the drive pulley 15. Thus, when the rope reel 14 rotates in the engine start direction, the distal end portion 16c of the ratchet member 16 engages with the recess portion 15c of the drive pulley 15 so that the torque of the rope reel 14 is transmitted to the drive pulley 15 through the recess portion 15c.

According to this embodiment, both the rotary shaft portion 16a and the distal end portion 16c of each ratchet member 16 suffering a load are provided in parallel with the rotation axis of the rope reel 14 (the reel support shaft 11). There is therefore no fear that the load is applied in a direction to tilt the ratchet member 16 or in a direction to make the ratchet member 16 drop out. Thus, the ratchet member 16 can be prevented from dropping out.

### (First Modification)

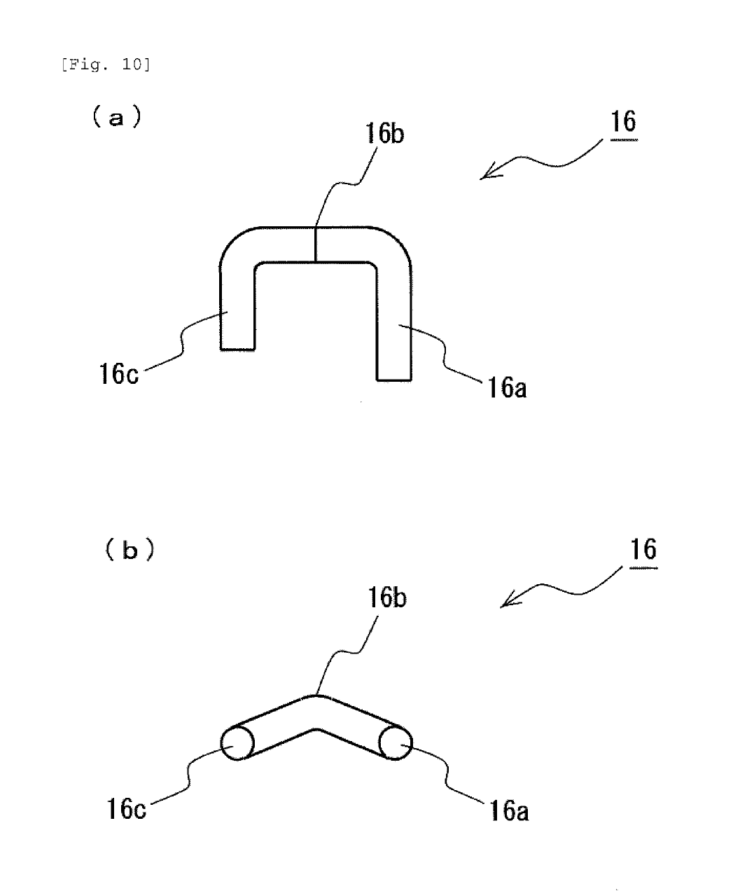

Ratchet members 16 in each of which an arm portion 16b is bent at an obtuse angle (e.g. 120 degrees) as shown in FIG. 10 may be used in place of the aforementioned ratchet members 16 according to the first embodiment and the second embodiment.

When such ratchet members 16 are used, each ratchet member 16 can be moved from the reception position to the engagement position with a small operating angle. Thus, the rotation angle of a backlash becomes small so that the rotation of the rope reel 14 can be transmitted to the drive pulley 15 efficiently.

### (Second Modification)

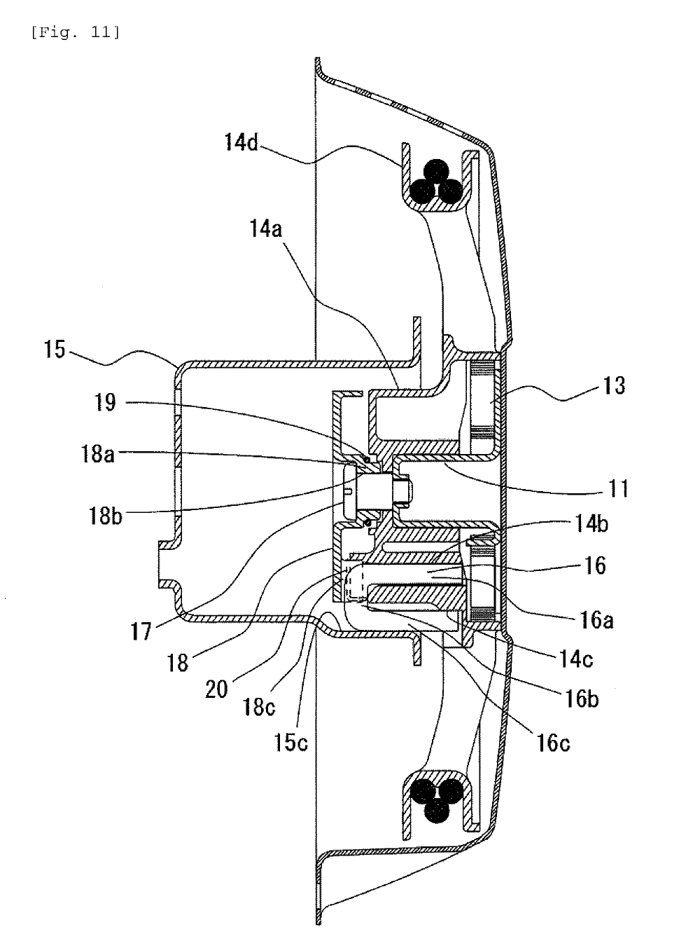

Ratchet members 16 and a rope reel 14 as shown in FIG. 11 may be used in place of the aforementioned ratchet members 16 and the rope reel 14 according to the second embodiment.

The rope reel 14 according to this second modification is provided with reception portions 14c for receiving distal end portions 16c of the ratchet members 16. In addition, in the ratchet members 16 according to the second modification, the distal end portions 16c are provided to be slightly long enough to be able to touch the reception portions 14c respectively.

Accordingly, as shown in FIG. 11, each ratchet member 16 is formed as follows. That is, when the distal end portion 16c of the ratchet member 16 rotates to protrude in the outer diameter direction and engages with the drive pulley 15, a part of the distal end portion 16c of the ratchet member 16 is supported on the reception portion 14c formed in the rope reel 14. Thus, when the rope reel 14 rotates in the engine start direction, the ratchet member 16 which has one end (the rotary shaft portion 16a) supported in the shaft hole 14b and the other end (the distal end portion 16c) supported on the reception portion 14c rotates together with the rope reel 14. On this occasion, the torque of the rope reel 14 is transmitted to the drive pulley 15 through the recess portion 15c because the distal end portion 16c of the ratchet member 16 engages with the recess portion 15c of the drive pulley 15.

As long as such ratchet members 16 and such rope reel 14 are used, even if a load on the engine side is applied to each ratchet member 16 when the ratchet member 16 engages with the drive pulley 15 so as to start the engine, the ratchet member 16 can be effectively prevented from tilting because the opposite end portions (the rotary shaft portion 16a and the distal end portion 16c) of the ratchet member 16 are supported on the rope reel 14.

In the ratchet member 16 according to the second modification, the arm portion 16b may be bent in an obtuse angle in the same manner as in the ratchet member 16 according to the first modification.

### REFERENCE SIGNS LIST

10 starter case
11 reel support shaft
12 recoil rope
13 recoil spring
14 rope reel
14a ratchet attachment portion
14b shaft hole
14c reception portion
14d reel portion
14e notch
15 drive pulley
15a inner peripheral surface
15b opening
15c recess portion
16 ratchet member
16a rotary shaft portion
16b arm portion
16c distal end portion
17 set screw
18 control member
18a cylindrical portion
18b screw hole
18c engagement portion
19 friction spring
20 torsion coil spring (urging unit)

1. A recoil starter comprising:
a rope reel in which a ratchet attachment portion is provided at the center thereof;
a drive pulley which is disposed to cover the ratchet attachment portion;
a ratchet member which is attached to the ratchet attachment portion and disposed on an inner side of the drive pulley; and
a control member which is attached coaxially with the rope reel so that the control member can rotate with friction resistance given thereto, and which has an engagement portion capable of engaging with the ratchet member; wherein:
a shaft hole is formed in the ratchet attachment portion and in parallel with a rotation axis of the rope reel;
the ratchet member is a wire-like member having a circular shape in section and rotatably attached to the shaft hole, and includes a rotary shaft portion which is inserted into the shaft hole, an arm portion which is extended from the rotary shaft portion and bent substantially at a right angle therewith, and a distal end portion which is extended from the arm portion and bent in parallel with the rotary shaft portion; and
the ratchet member is further arranged so that, when the rope reel rotates in an engine start direction, the arm portion is thrust against the engagement portion of the control member so that the distal end portion is rotated to protrude in an outer diameter direction and the rotated distal end portion engages with the drive pulley so as to transmit torque of the rope reel to the drive pulley.

2. A recoil starter according to claim 1, wherein: an opening is formed in the drive pulley so that the distal end portion of the ratchet member rotated to protrude in the outer diameter direction can penetrate the opening.

3. A recoil starter according to claim 1, wherein: a recess portion for receiving the distal end portion of the ratchet member rotated to protrude in the outer diameter direction is formed in the drive pulley.

4. A recoil starter according to claim 2, wherein: when the distal end portion of the ratchet member is rotated to protrude in the outer diameter direction to thereby engage with the drive pulley, the distal end portion is supported by a reception portion formed in the rope pulley.

5. A recoil starter according to claim 1, further comprising:
an urging unit for urging the ratchet member in a direction to prevent the distal end portion from protruding in the outer diameter direction.

6. A recoil starter according to claim 3, wherein: when the distal end portion of the ratchet member is rotated to protrude in the outer diameter direction to thereby engage with the drive pulley, the distal end portion is supported by a reception portion formed in the rope pulley.

7. A recoil starter according to claim 2, further comprising:
an urging unit for urging the ratchet member in a direction to prevent the distal end portion from protruding in the outer diameter direction.

8. A recoil starter according to claim 3, further comprising:
an urging unit for urging the ratchet member in a direction to prevent the distal end portion from protruding in the outer diameter direction.

9. A recoil starter according to claim 4, further comprising:
an urging unit for urging the ratchet member in a direction to prevent the distal end portion from protruding in the outer diameter direction.
